(19) United States
(12) Patent Application Publication
(10) Pub. No.: US 2024/0345511 A1
(43) Pub. Date: Oct. 17, 2024

(54) IMAGE FORMING APPARATUS

(71) Applicant: KYOCERA Document Solutions Inc., Osaka (JP)

(72) Inventors: Yohei WAKASA, Osaka (JP); Keiya NISHIMURA, Osaka (JP)

(73) Assignee: KYOCERA Document Solutions Inc., Osaka (JP)

(21) Appl. No.: 18/627,774

(22) Filed: Apr. 5, 2024

(30) Foreign Application Priority Data
Apr. 13, 2023 (JP) 2023-065609

(51) Int. Cl. G03G 15/16; G03G 21/00

(52) U.S. Cl. CPC G03G 15/161; G03G 15/1645; G03G 21/0058

(57) ABSTRACT

In the image forming apparatus, a controller makes a reference image formed on an outer circumferential surface of an image carrier and transferred to a belt. Then, uncollected toner of the reference image, which is part of after-transfer remaining toner of the reference image that has missed being collected so as to remain even after one-round rotation of the image carrier, is transferred to the belt. The controller measures a collectable toner quantity corresponding to an applied voltage of the cleaning roller on a basis of an uncollected toner quantity estimated based on a toner concentration of the uncollected toner, and executes such adjustment that the collectable toner quantity becomes equal to or larger than a maximum value of the after-transfer remaining toner quantity and moreover the applied voltage becomes equal to or lower than a maximum applicable voltage.

### INCORPORATION BY REFERENCE

This application is based on and claims the benefit of priority from Japanese Patent Application No. 2023-065609 filed on Apr. 13, 2023, the contents of which are hereby incorporated by reference.

### BACKGROUND

The present disclosure relates to an image forming apparatus.

In an image forming apparatus of electrophotographic system such as copiers and printers, there has been widely used a device for forming a toner image, which is to be transferred onto a paper sheet in later process, by feeding toner and executing development for an electrostatic latent image formed on an outer circumferential surface of a photosensitive drum serving as an image carrier. With such an image forming apparatus, there is a need for collecting after-transfer remaining toner, which has missed being fully transferred from the photosensitive drum onto a paper sheet or other transfer-objective material so as to remain on the photosensitive drum, in order that such after-transfer remaining toner does not affect subsequent image formation.

### SUMMARY

An image forming apparatus according to one aspect of the present disclosure includes an image carrier, a charging part, an exposure part, a developing part, a belt, a transfer part, a cleaning roller, a voltage application part, a concentration detection part, and a controller. In the image carrier, a photosensitive layer is formed on its outer circumferential surface. The charging part electrically charges the outer circumferential surface of the image carrier to a specified surface potential. The exposure part makes the outer circumferential surface of the image carrier, which has been electrically charged by the charging part, exposed to light to form an electrostatic latent image with its charging level attenuated. The developing part feeds toner to the electrostatic latent image on the image carrier to form a toner image, and moreover collects the toner remaining on the outer circumferential surface of the image carrier. The belt is placed so as to face the image carrier. The transfer part transfers the toner image, which has been formed on the outer circumferential surface of the image carrier, onto an outer circumferential surface of the belt. The cleaning roller removes and collects deposits on the outer circumferential surface of the image carrier. The voltage application part applies voltages for the charging part, the developing part, the transfer part, and the cleaning roller. The concentration detection part detects a toner concentration of the toner image transferred onto the outer circumferential surface of the belt. The controller controls the image carrier, the charging part, the developing part, the transfer part, the cleaning roller, and the voltage application part. The controller makes a reference image, which is the toner image, formed on the outer circumferential surface of the image carrier and transferred onto the outer circumferential surface of the belt. The controller makes uncollected toner of the reference image, which is part of after-transfer remaining toner of the reference image that has missed being collected by the cleaning roller and the developing part and remains even after one-round rotation of the image carrier, transferred to the outer circumferential surface of the belt. The controller estimates an uncollected toner quantity on a basis of the toner concentration of the uncollected toner detected by the concentration detection part, and moreover measures a collectable toner quantity corresponding to an applied voltage of the cleaning roller on a basis of the uncollected toner quantity. The controller adjusts the applied voltage of the cleaning roller so that the collectable toner quantity becomes equal to or larger than a maximum value of the after-transfer remaining toner quantity while the applied voltage of the cleaning roller becomes equal to or lower than a maximum applicable voltage.

### BRIEF DESCRIPTION OF THE DRAWINGS

FIG. 1 is a schematic cross-sectional front view of an image forming apparatus according to one embodiment of the present disclosure;

FIG. 2 is a block diagram showing a configuration of the image forming apparatus of FIG. 1;

FIG. 3 is a schematic cross-sectional front view of around an image forming part in the image forming apparatus of FIG. 1;

FIG. 4 is a graph showing a relationship between transfer current for an intermediate transfer belt and on-belt toner quantity;

FIG. 5 is a plan view of the intermediate transfer belt as well as a schematic diagram showing a primarily transferred reference image and a state of uncollected toner of the reference image;

FIG. 6 is a graph showing a relationship between after-transfer remaining toner quantity on a photosensitive drum and uncollected toner quantity;

FIG. 7 is a graph showing a relationship between applied voltage of a cleaning roller and collectable toner quantity; and

FIG. 8 is a graph showing variations of surface potential of photosensitive drums in image forming apparatuses according to the embodiment and a comparative example.

### DETAILED DESCRIPTION

Hereinafter, an embodiment of the present disclosure will be described with reference to the accompanying drawings. It is to be noted that the present disclosure is not limited to the following contents.

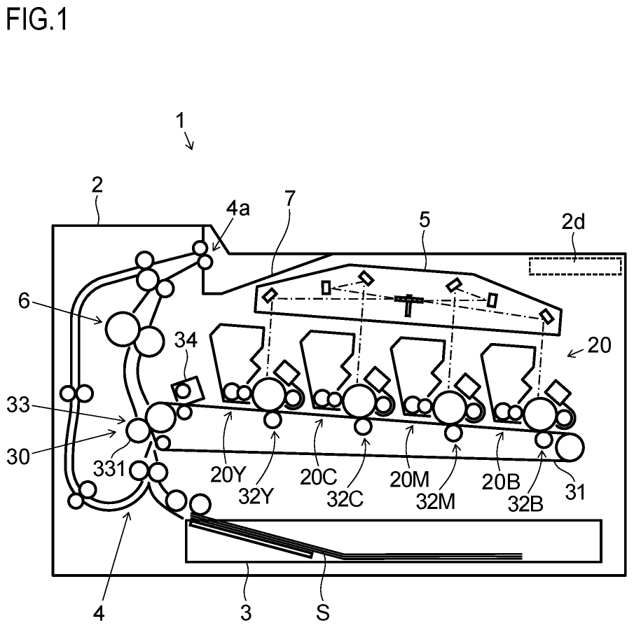

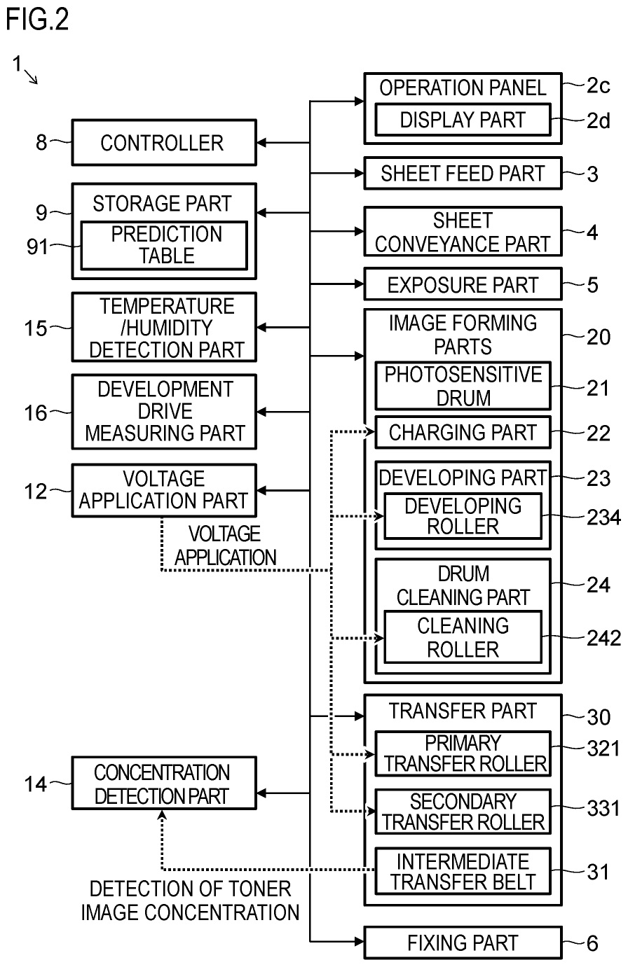

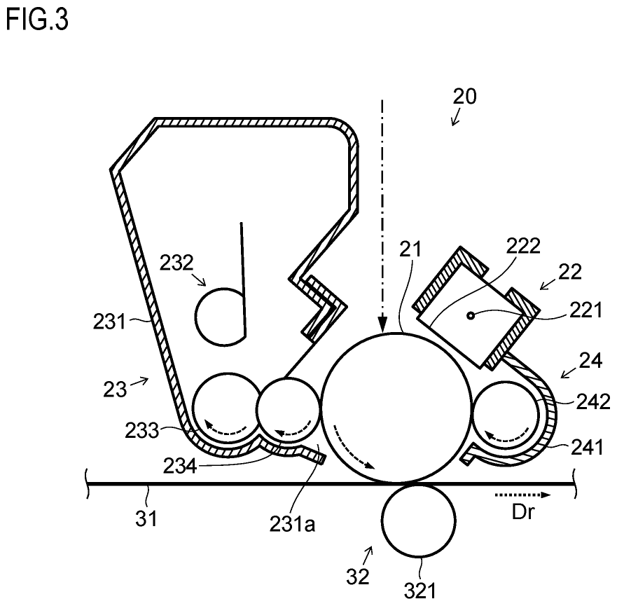

FIG. 1 is a schematic cross-sectional front view of an image forming apparatus 1 according to this embodiment. FIG. 2 is a block diagram showing a configuration of the image forming apparatus 1 of FIG. 1. FIG. 3 is a schematic cross-sectional front view of around an image forming part 20 in the image forming apparatus 1 of FIG. 1. One example of the image forming apparatus 1 according to this embodiment is a tandem-type color printer in which upon accepting image data and print instructions associated with a print job from an external computer, a toner image is transferred onto a paper sheet S with use of an intermediate transfer belt 31. The image forming apparatus 1 may also be a so-called multifunction peripheral equipped with such functions as printing, scanning (image reading), and facsimile transmission.

As shown in FIGS. 1, 2 and 3, the image forming apparatus 1 includes a sheet feed part 3, a sheet conveyance part 4, an exposure part 5, image forming parts 20, a transfer part 30, a fixing part 6, a sheet discharge part 7, a controller 8, and a storage part 9, as these are provided in an apparatus housing 2.

The housing 2 is equipped with an operation panel 2c. The operation panel 2c is placed at an frontal upper portion of the housing 2, as an example, with a display part 2d such as a liquid crystal display included therein. The operation panel 2c displays, on the display part 2d, settings as to print conditions such as type and size of a sheet S to be used for printing, scale-up and scale-down, one-sided printing or double-sided printing or one-page intensive printing, as well as screen images associated with entry of an execution instruction or the like, and moreover the operation panel 2c accepts those entries directly from an apparatus user. Further, the display part 2d also serves as an informing part that displays, for example, statuses of the image forming apparatus 1, notices, error massages and the like so as to make those pieces of information knowable to the user.

The sheet feed part 3 is placed at a bottom portion of the housing 2. The sheet feed part 3, containing a plurality of unprinted paper sheets S, separates a sheet S therefrom and feeds out the sheet S one by one on occasions of printing. The sheet conveyance part 4 extends in an up/down direction along a side wall of the housing 2. The sheet conveyance part 4 conveys a sheet S, which has been fed out from the sheet feed part 3, to a secondary transfer part 33 and the fixing part 6, and further discharges the after-fixation sheet S through a sheet discharge port 4a to the sheet discharge part 7. The exposure part 5 is placed at an upper portion in the housing 2. The exposure part 5 applies laser light, which has been controlled based on image data, toward the image forming parts 20.

The image forming parts 20 are placed below the exposure part 5 and above the intermediate transfer belt 31. The image forming parts 20 include a yellow-destined image forming part 20Y, a cyan-destined image forming part 20C, a magenta-destined image forming part 20M, and a black-destined image forming part 20B. These four image forming parts 20 are identical in basic configuration. Therefore, hereinafter, unless otherwise necessarily particularly limited, the identification signs ‘Y’, ‘C’, ‘M’ and ‘B’ representing individual colors, respectively, may be omitted from time to time.

Each image forming part 20 includes a photosensitive drum (image carrier) 21 which is supported rotatable in a specified direction (counterclockwise in FIGS. 1 and 3). The image forming part 20 further includes a charging part 22, a developing part 23, and a drum cleaning part (cleaning part) 24, as these are disposed around the photosensitive drum 21 along its rotational direction. In addition, a primary transfer part 32 is placed between the developing part 23 and the drum cleaning part 24.

The photosensitive drum 21 has a photosensitive layer formed on its outer circumferential surface. The charging part 22 electrically charges the outer circumferential surface of the photosensitive drum 21 to a specified surface potential. The exposure part 5 illuminates the outer circumferential surface of the photosensitive drum 21 charged by the charging part 22 so that an electrostatic latent image of an original image with its charging level attenuated is formed on the outer circumferential surface of the photosensitive drum 21. The developing part 23, by feeding toner to the electrostatic latent image on the outer circumferential surface of the photosensitive drum 21, makes the electrostatic latent image developed to form a toner image. The four image forming parts 20 form toner images of different colors, respectively.

After a toner image is primarily transferred onto an outer circumferential surface of the intermediate transfer belt 31, the drum cleaning part 24 removes and collects toner and other deposits remaining on the outer circumferential surface of the photosensitive drum 21. Toner that has missed being fully collected by the drum cleaning part 24 and remaining on the outer circumferential surface of the photosensitive drum 21 is collected by the developing part 23 after having passed through the charging part 22. In this way, the image forming parts 20 form an image (toner image) that is to be transferred onto the sheet S in later process.

The transfer part 30 includes an intermediate transfer belt (belt) 31, primary transfer parts 32Y, 32C, 32M, 32B, a secondary transfer part 33, and a belt cleaning part 34. The intermediate transfer belt 31 is placed below the four image forming parts 20 and above the sheet feed part 3. The intermediate transfer belt 31 is placed so as to face the four photosensitive drums 21. The intermediate transfer belt 31 is an endless intermediate transferer which is supported so as to be turnable in a specified direction (clockwise in FIG. 1) and to which toner images formed by the four image forming parts 20, respectively, are primarily transferred in superimposition one after another. The four image forming parts 20 are placed in such a so-called tandem mode as to be arrayed in one line from upstream side toward downstream side of a turning direction of the intermediate transfer belt 31.

The primary transfer parts 32Y, 32C, 32M, 32B are placed under the individual-color image forming parts 20Y, 20C, 20M, 20B, respectively, with the intermediate transfer belt 31 pinched therebetween. The secondary transfer part 33 is placed upstream of the fixing part 6 in a sheet conveyance direction of the sheet conveyance part 4, as well as downstream of the four image forming parts 20Y, 20C, 20M, 20B in the turning direction of the intermediate transfer belt 31. The belt cleaning part 34 is placed downstream of the secondary transfer part 33 in the turning direction of the intermediate transfer belt 31.

Each primary transfer part 32 transfers a toner image, which has been formed on the outer circumferential surface of the photosensitive drum 21, onto the outer circumferential surface of the intermediate transfer belt 31. In other words, the toner image is primarily transferred onto the outer circumferential surface of the intermediate transfer belt 31 at the individual-color primary transfer parts 32Y, 32C, 32M, 32B. Then, by the toner images of the four image forming parts 20 being transferred to the intermediate transfer belt 31 successively in superimposition at specified timings along with the turning of the intermediate transfer belt 31, a color toner image in which four-color toner images of yellow, cyan, magenta and black have been superimposed together is formed on the outer circumferential surface of the intermediate transfer belt 31.

The color toner image on the outer circumferential surface of the intermediate transfer belt 31 is transferred onto the sheet S fed in synchronization by the sheet conveyance part 4 at a secondary transfer nip portion formed in the secondary transfer part 33. The belt cleaning part 34 removes toner and other deposits remaining on the outer circumferential surface of the intermediate transfer belt 31 after secondary transfer, fulfilling the cleaning function. In this way, the transfer part 30 transfers (records) the toner image, which has been formed on the outer circumferential surface of the photosensitive drum 21, onto the sheet S.

The fixing part 6 is placed upward of the secondary transfer part 33. The fixing part 6 heats and pressurizes the sheet S, onto which the toner image has been transferred, so as to fix the toner image on the sheet S.

The sheet discharge part 7 is placed upward of the transfer part 30. The sheet S, on which the toner image has been fixed and for which printing is over, is conveyed to the sheet discharge part 7. The sheet discharge part 7 allows an after-printing sheet (printed matter) to be taken out from upward.

The controller 8 includes a CPU, an image processing part, and other electronic circuits and electronic components (none shown). The CPU, based on control programs and data stored in the storage part 9, controls operations of the individual component elements provided in the image forming apparatus 1 to execute processing related to functions of the image forming apparatus 1. The sheet feed part 3, the sheet conveyance part 4, the exposure part 5, the image forming parts 20, the transfer part 30 and the fixing part 6 receive instructions individually from the controller 8 to fulfill printing on the sheet S in linkage with one another.

The storage part 9 is made up, for example, by a combination of nonvolatile storage device such as program ROM (Read Only Memory), data ROM, or the like (not shown) and volatile storage device such as RAM (Random Access Memory) (not shown).

Also, the image forming apparatus 1, as shown in FIGS. 1 and 2, further includes a voltage application part 12 and a concentration detection part 14.

The voltage application part 12 includes, for example, a power supply part and a control circuit (neither shown). The voltage application part 12 is electrically connected to a charging wire 221 and a grid electrode 222 of the charging part 22, a developing roller 234 of the developing part 23, a cleaning roller 242 of the drum cleaning part 24, and a primary transfer roller 321 and a secondary transfer roller 331 of the transfer part 30. The voltage application part 12 controls electrical energization for the charging part 22, the developing part 23, the cleaning roller 242, and the transfer part 30.

In more detail, the voltage application part 12 applies a charging current to the charging wire 221 and a charging voltage to the grid electrode 222, applies a developing voltage (developing bias) to the developing roller 234, applies a cleaning voltage (cleaning bias) to the cleaning roller 242, and applies transfer voltages (transfer currents) to the primary transfer roller 321 and the secondary transfer roller 331. Via the voltage application part 12, the controller 8 controls application timing, voltage value (current value), polarity, application time, and the like of the voltages (currents) for the charging wire 221, the grid electrode 222, the developing roller 234, the cleaning roller 242, and the primary transfer roller 321 and the secondary transfer roller 331, respectively.

The concentration detection part 14 is placed upstream of the secondary transfer part 33 in the turning direction of the intermediate transfer belt 31. The concentration detection part 14 faces the outer circumferential surface of the intermediate transfer belt 31. The concentration detection part 14 is equipped with a reflection-type optical sensor which includes a light-emitting part including, e.g., LEDs (Light Emitting Diodes) or other light-emitting elements and a light-receiving part including, e.g., photodiodes or other light-receiving elements. The light-emitting part emits, at a specified angle, detection light toward a toner image transferred onto the outer circumferential surface of the intermediate transfer belt 31. The light-receiving part illuminates the toner image and receives detection light reflected by the toner image.

The light-receiving part includes a regular-reflection-light receiving part for receiving regular-reflection light and a diffuse-reflection-light receiving part for receiving diffuse-reflection light, each out of detection light reflected by the toner image. In the absence of toner on the outer circumferential surface of the intermediate transfer belt 31, detection light emitted from the light-emitting part is not diffusely reflected but regularly reflected by toner, thus mostly becoming incident on the regular-reflection-light receiving part. Then, as toner quantity on the outer circumferential surface of the intermediate transfer belt 31 increases more and more, larger and larger quantity of light is diffusely reflected by the toner, so that quantity of incident light on the diffuse-reflection-light receiving part gradually increases more and more.

As described above, the concentration detection part 14 emits detection light from the light-emitting part toward a toner image. Then, based on detection light reflected by the toner image and received by the light-receiving part (regular-reflection-light receiving part and diffuse-reflection-light receiving part), the concentration detection part 14 detects a toner concentration of the toner image transferred onto the outer circumferential surface of the intermediate transfer belt 31.

Next, a configuration of each image forming part 20 and its peripheries will be described with reference to FIG. 3. It is noted that since the individual-color image forming parts 20 are identical in basic configuration, notation of identification signs representing individual colors of configurational elements, as well as their description, will be omitted unless otherwise necessarily particularly limited.

Each image forming part 20 includes a photosensitive drum 21, a charging part 22, a developing part 23, and a drum cleaning part 24.

The photosensitive drum 21, which is formed into a cylindrical shape supported rotatable with its center axis horizontal, is rotated at a constant speed about a center axis by a driving part (not shown). The photosensitive drum 21 has a photosensitive layer formed of, e.g., an organic photoconductor (OPC) on an outer circumferential surface of, e.g., an aluminum or other metallic drum material pipe. An electrostatic latent image is formed on the outer circumferential surface of the photosensitive drum 21.

The charging part 22 is placed so as to face the outer circumferential surface of the photosensitive drum 21 with a specified clearance provided therebetween. The charging part 22 includes a charging wire 221 and a grid electrode 222. The charging wire 221, which is a linear electrode extending parallel to an axial direction of the photosensitive drum 21, generates corona discharge against the photosensitive drum 21. The grid electrode 222, which is a grid-shaped electrode extending in the axial direction of the photosensitive drum 21, is placed between the charging wire 221 and the photosensitive drum 21. When a specified charging current is applied to the charging wire 221, the charging part 22 generates corona discharge. Further, when a specified charging voltage is applied to the grid electrode 222, the charging part 22 makes the outer circumferential surface (surface) of the photosensitive drum 21 uniformly charged to a specified surface potential.

The developing part 23 is placed downstream of the charging part 22 in the rotational direction of the photosensitive drum 21. The developing part 23 includes a development container 231, a stirring paddle 232, a feed roller 233, and a developing roller 234.

The development container 231, which is formed into a slender shape extending along the axial direction (drawing-sheet depthwise direction of FIG. 3) of the photosensitive drum 21, is placed with its longitudinal direction horizontal. The development container 231 has an opening 231a at one portion facing the photosensitive drum 21. The development container 231 contains nonmagnetic one-component toner as a developer. That is, the development container 231 contains toner to be fed to the photosensitive drum 21.

The stirring paddle 232 is placed at an upper position within the development container 231 so as to be distant from the opening 231a beyond the developing roller 234 and the feed roller 233. The stirring paddle 232 is supported by the development container 231 so as to be rotatable about an axis line extending parallel to the photosensitive drum 21. The stirring paddle 232 further includes a flexible film portion extending in its radial direction. The stirring paddle 232 is rotated about the axis line to stir toner present in the development container 231.

The feed roller 233 is placed at a lower position within the development container 231 between the opening 231a and the stirring paddle 232. The feed roller 233 is placed so as to face the developing roller 234. The feed roller 233 is supported by the development container 231 so as to be rotatable about an axis line extending parallel to the photosensitive drum 21. The feed roller 233 carries toner, which is to be fed to an outer circumferential surface of the developing roller 234, in a facing region with the developing roller 234. The feed roller 233 is rotated in the same direction as the developing roller 234.

The developing roller 234, which is placed at the opening 231a of the development container 231, is partly exposed from the development container 231. The developing roller 234 is placed so as to face the photosensitive drum 21 in contact with the photosensitive drum 21. The developing roller 234 is supported by the development container 231 so as to be rotatable about an axis line extending parallel to the axis line of the photosensitive drum 21. The developing roller 234 carries toner, which is to be fed to the outer circumferential surface of the photosensitive drum 21, in a facing region with the photosensitive drum 21. The developing roller 234 is rotated in a direction reverse to that of the photosensitive drum 21. The developing roller 234 feeds toner present in the development container 231 to the outer circumferential surface of the photosensitive drum 21, and makes the electrostatic latent image developed to form a toner image.

The drum cleaning part 24 is placed downstream of the primary transfer part 32 in the rotational direction of the photosensitive drum 21. The drum cleaning part 24 includes a collection container 241, and a cleaning roller 242.

The collection container 241, which is formed into a slender shape extending along the axial direction (drawing-sheet depthwise direction of FIG. 3) of the photosensitive drum 21, is placed with its longitudinal direction horizontal. The collection container 241 contains toner and other deposits removed, and collected, from the outer circumferential surface of the photosensitive drum 21 by the cleaning roller 242.

The cleaning roller 242, which is partly exposed from the collection container 241, is placed so as to face the photosensitive drum 21. The cleaning roller 242 is supported by the collection container 241 so as to be rotatable about an axis line extending parallel to the axis line of the photosensitive drum 21. The cleaning roller 242 is provided by, e.g., a sponge roller having a specified cell diameter. The cleaning roller 242 is set in contact, at a specified pressure, with the outer circumferential surface of the photosensitive drum 21. The cleaning roller 242 removes and collects toner and other deposits remaining on the outer circumferential surface of the photosensitive drum 21 after the primary transfer.

The cleaning roller 242 collects toner into sponge cells. As cumulated drive time of the drum cleaning part 24 is prolonged, toner is deposited in cells, making it harder for the cleaning roller 242 to collect toner. Toner collection performance by the cleaning roller 242 can be improved by properly adjusting the applied voltage (cleaning bias) for the cleaning roller 242.

Accordingly, the controller 8 of the image forming apparatus 1 in this embodiment executes calibration for adjusting applied voltage of the cleaning roller 242 under a situation other than image formation on a regular basis such as a predetermined number-of-printed-sheets basis or at an arbitrary timing of user's or manager's discretion.

In this calibration, the controller 8 forms, on the outer circumferential surface of the photosensitive drum 21, a reference image (patch image) which is a toner image for use in adjustment of the applied voltage of the cleaning roller 242, and then makes the reference image transferred onto the outer circumferential surface of the intermediate transfer belt 31. In this process, uncollected toner of the reference image, which has been collected by neither the cleaning roller 242 nor the developing part 23 so as to remain as after-transfer remaining toner of the reference image over one-round rotation of the photosensitive drum 21, is transferred onto the outer circumferential surface of the intermediate transfer belt 31, followed by detecting a concentration of the uncollected toner by the concentration detection part 14. Based on a detection result, the controller 8 estimates a quantity of uncollected toner, measures a collectable toner quantity corresponding to the applied voltage of the cleaning roller 242, and adjusts the applied voltage of the cleaning roller 242 such that the resulting collectable toner quantity falls within a specified range.

Next, the calibration for adjusting the applied voltage of the cleaning roller 242 will be described in detail.

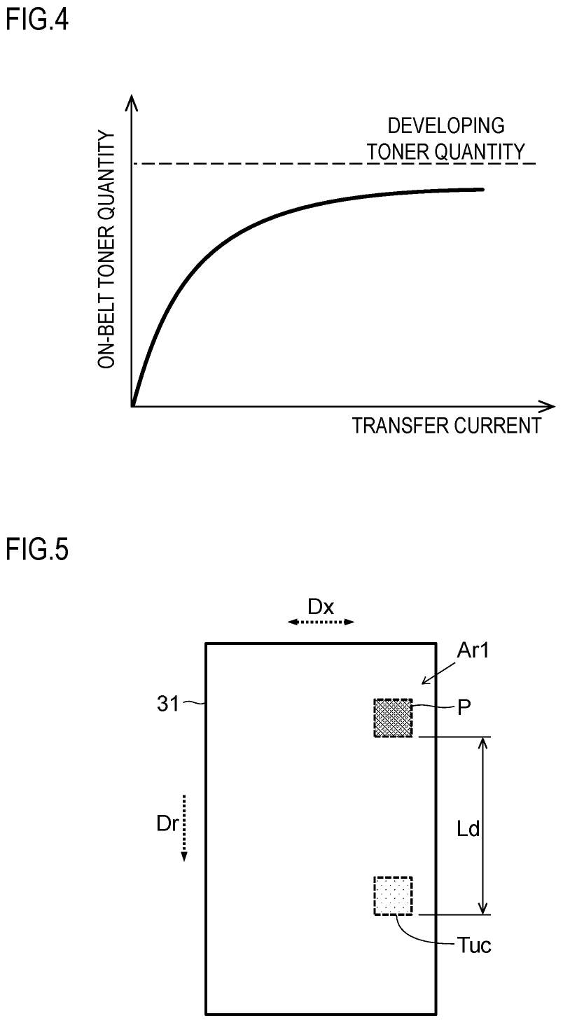

FIG. 4 is a graph showing a relationship between transfer current for the intermediate transfer belt 31 and on-belt toner quantity. In the graph shown in FIG. 4, the horizontal axis represents transfer current applied to the primary transfer roller 321, and the vertical axis represents on-belt toner quantity primarily transferred from the photosensitive drum 21 to the intermediate transfer belt 31 in response to the transfer current. With respect to a toner image transferred onto the outer circumferential surface of the intermediate transfer belt 31, the on-belt toner quantity is estimated based on a level of toner concentration detected by the concentration detection part 14. It can be understood that, as shown in FIG. 4, the higher the transfer current becomes, the more the on-belt toner quantity increases.

Broken line shown in FIG. 4 represents quantity of developing toner that has been fed from the developing part 23 to the photosensitive drum 21 for formation of a toner image. The developing toner quantity is predicted from the quantity of on-belt toner that has been transferred onto the outer circumferential surface of the intermediate transfer belt 31 by utilizing a prediction table 91 previously stored in the storage part 9.

In terms of utilization of the prediction table 91, the image forming apparatus 1 includes, for example, a temperature/humidity detection part 15 and a development drive measuring part 16. The temperature/humidity detection part 15 detects temperature and humidity of an ambient environment of the image forming apparatus 1. The development drive measuring part 16 measures a drive state of the developing part 23 and measures an extent to which toner within the developing part 23 has been deteriorated. By using a temperature and a humidity detected by the temperature/humidity detection part 15 as well as a toner state measured by the development drive measuring part 16, the controller 8 acquires, from the prediction table 91, a correction factor corresponding to the on-belt toner quantity. Then, the controller 8 predicts a developing toner quantity by multiplying a saturation value of on-belt toner quantity by the correction factor.

Based on a difference between the developing toner quantity predicted by using the prediction table 91 and the on-belt toner quantity, the controller 8 calculates an after-transfer remaining toner quantity. The after-transfer remaining toner means toner which has been fed from the developing part 23 to the photosensitive drum 21 and which remains on the photosensitive drum 21 without being transferred to the outer circumferential surface of the intermediate transfer belt 31 during the primary transfer. As far as FIG. 4 is concerned, the after-transfer remaining toner quantity equals a difference between the developing toner quantity represented by broken line and the on-belt toner quantity represented by curved line.

FIG. 5 is a plan view of the intermediate transfer belt 31 as well as a schematic diagram showing a primarily transferred reference image P and a state of uncollected toner Tuc of the reference image P. Arrowed line Dr shown in FIG. 5 represents a rotational direction of the intermediate transfer belt 31, and arrowed line Dx represents an axial direction (axial direction of the photosensitive drum 21, sheet-widthwise direction) of an installation roller (not shown) of the intermediate transfer belt 31.

The controller 8 makes the reference image P, which is a toner image, formed on the outer circumferential surface of the photosensitive drum 21, and then as shown in FIG. 5, makes the reference image P transferred onto the outer circumferential surface of the intermediate transfer belt 31. It is noted that a transfer area Ar1 for the reference image P on the intermediate transfer belt 31 is an area which allows the transfer current of the primary transfer roller 321 to be arbitrarily varied from time to time. Varying the transfer current causes increases or decreases in the after-transfer remaining toner quantity remaining on the photosensitive drum 21 after the primary transfer.

The after-transfer remaining toner of the reference image P remaining on the photosensitive drum 21 is collected by the cleaning roller 242 and the developing part 23. However, the after-transfer remaining toner of the reference image P, when having missed being fully collected by the cleaning roller 242 and the developing part 23, remains even after one-round rotation of the photosensitive drum 21. Uncollected toner Tuc of the reference image P remaining even after one-round rotation of the photosensitive drum 21 reaches the primary transfer part 32 once again. Arrowed line Ld shown in FIG. 5 represents a length corresponding to one-round rotation of the photosensitive drum 21. The controller 8 makes the uncollected toner Tuc of the reference image P, which remains even after one-round rotation of the photosensitive drum 21, transferred onto the outer circumferential surface of the intermediate transfer belt 31.

Further, the controller 8, by using the concentration detection part 14, detects a toner concentration of the uncollected toner Tuc of the reference image P transferred onto the outer circumferential surface of the intermediate transfer belt 31. Then, the controller 8 estimates an uncollected toner quantity based on the toner concentration of the uncollected toner Tuc detected by the concentration detection part 14. In this process, the controller 8 varies the transfer current as described before to increase or decrease the after-transfer remaining toner quantity remaining on the photosensitive drum 21 after the primary transfer, i.e., to increase or decrease the uncollected toner quantity.

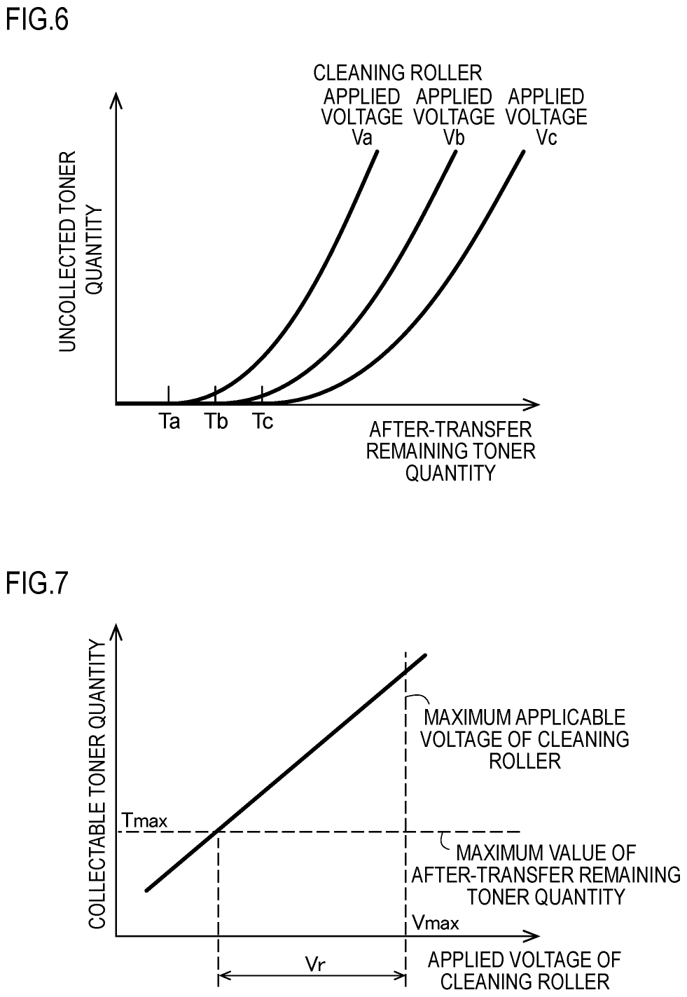

FIG. 6 is a graph showing a relationship between after-transfer remaining toner quantity on the photosensitive drum and uncollected toner quantity. In the graph shown in FIG. 6, the horizontal axis represents after-transfer remaining toner quantity of the reference image P remaining on the photosensitive drum 21, and the vertical axis represents uncollected toner quantity of the reference image P transferred to the intermediate transfer belt 31, which has missed being fully collected by the cleaning roller 242 and the developing part 23 and which remains even after one-round rotation of the photosensitive drum 21, versus the after-transfer remaining toner quantity.

Referring to FIG. 6, the controller 8 varies the applied voltage (cleaning bias) of the cleaning roller 242 in plural steps of Va, Vb and Vc to measure uncollected toner quantity versus after-transfer remaining toner quantity. As shown in FIG. 6, in a case with a low level of after-transfer remaining toner quantity (horizontal axis), the after-transfer remaining toner is collected by the cleaning roller 242 and the developing part 23, resulting in an uncollected toner quantity (vertical axis) of 0. With increasing after-transfer remaining toner quantity, the uncollected toner quantity also increases gradually, resulting in such a curved line as shown in FIG. 6.

The higher the applied voltage (cleaning bias) of the cleaning roller 242 becomes, i.e. with an order of applied voltages Va<Vb<Vc, the more the collectable after-transfer remaining toner quantity, i.e. collectable toner quantity, increases. Thus, based on an uncollected toner quantity, the controller 8 measures a collectable toner quantity corresponding to an applied voltage of the cleaning roller 242. In more detail with reference to FIG. 6, the controller 8 measures a collectable toner quantity Ta corresponding to the applied voltage Va of the cleaning roller 242, a collectable toner quantity Tb corresponding to the applied voltage Vb, and a collectable toner quantity Tc corresponding to the applied voltage Vc.

FIG. 7 is a graph showing a relationship between applied voltage of the cleaning roller 242 and collectable toner quantity. In the graph shown in FIG. 7, the horizontal axis represents applied voltage of the cleaning roller 242, and the vertical axis represents collectable toner quantity (collectable quantity of after-transfer remaining toner). Broken line Tmax that extends horizontally as shown in FIG. 7 represents a maximum value of the after-transfer remaining toner quantity. Broken line Vmax that extends vertically as shown in FIG. 7 represents a maximum applicable voltage for the cleaning roller 242.

In order that the uncollected toner quantity results in a zero, there is a need for adjusting the applied voltage of the cleaning roller 242 so as to keep the collectable toner quantity at or over the maximum value Tmax of the after-transfer remaining toner quantity. Meanwhile, as to the applied voltage of the cleaning roller 242, there is defined a maximum applicable voltage Vmax that is an upper-limit value in terms of performance of the voltage application part 12. Due to this, the controller 8 adjusts the applied voltage of the cleaning roller 242 in such fashion that the collectable toner quantity becomes equal to or more than the maximum value Tmax of the after-transfer remaining toner quantity and moreover the applied voltage of the cleaning roller 242 becomes equal to or less than the maximum applicable voltage Vmax. In more detail with reference to FIG. 7, the controller 8 adjusts the applied voltage of the cleaning roller 242 such that the applied voltage falls within a range Vr.

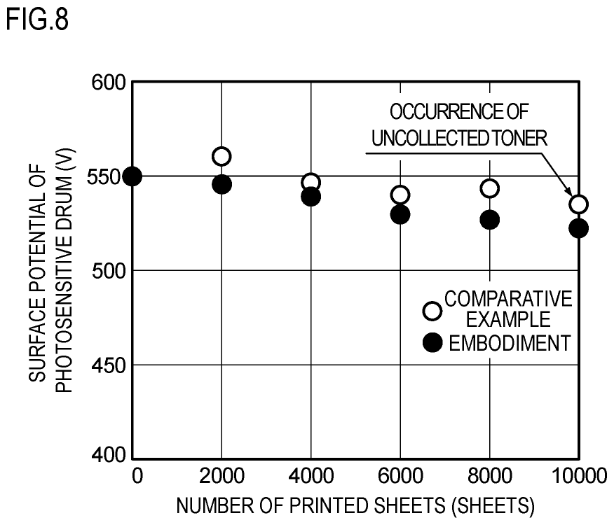

FIG. 8 is a graph showing variations of surface potential of photosensitive drums in image forming apparatuses according to the embodiment and a comparative example. Referring to the graph shown in FIG. 8, the horizontal axis represents number of printed sheets in the image forming apparatuses, and the vertical axis represents surface potential (V) of the photosensitive drums. FIG. 8 shows variations of surface potential of the photosensitive drums on a number-of-printed-sheets basis in the image forming apparatus 1 of the embodiment that has been subjected to the above-described calibration for adjustment of the applied voltage of the cleaning roller 242, as well as in the image forming apparatus of the comparative example subjected to no calibration.

According to FIG. 8, in the embodiment in which toner collection performance by the cleaning roller 242 has been improved by execution of the calibration, the surface potential of the photosensitive drum 21 has proved lower than in the comparative example. However, in the embodiment, preferable image formation has been accomplished without involving occurrence of transfer memory (a defect in which an image pattern used in preceding-time image formation emerges on an image during succeeding-time image formation upon completion of one-round rotation of the photosensitive drum). By contrast, in the comparative example in which no calibration is executed, uncollected toner occurred at a time point of 10,000 printed sheets.

By virtue of executing the calibration in which adjustment of the applied voltage of the cleaning roller 242 is executed as described above, a collectable toner quantity corresponding to after-transfer remaining toner that has missed being fully collected so as to remain on the photosensitive drum 21 is measured, and the applied voltage of the cleaning roller 242 is adjusted based on the collectable toner quantity. Using an applied voltage of the cleaning roller 242 that has been adjusted in the above-described way makes it possible to preferably collect the after-transfer remaining toner on the photosensitive drum 21. As a result, the uncollected toner quantity becomes a zero, allowing high-quality image formation to be achieved.

As the applied voltage of the cleaning roller 242 becomes higher and higher, it becomes more and more likely that the surface potential of the photosensitive drum 21 decreases or the transfer memory occurs. Adjusting the applied voltage of the cleaning roller 242 so that the the collectable toner quantity becomes equal to or larger than the maximum value Tmax of the after-transfer remaining toner quantity makes it possible to satisfy toner collection performance by the cleaning roller 242 and moreover suppress decreases in the surface potential of the photosensitive drum 21 as well as occurrence of the transfer memory.

Further, by virtue of varying the applied voltage of the cleaning roller 242 in plural steps in the measurement of uncollected toner quantity, uncollected toner quantity versus after-transfer remaining toner quantity can be measured at different applied voltages, contributing to improvement of measurement-result reliability. That is, it becomes implementable to preferably measure a collectable toner quantity based on an uncollected toner quantity corresponding to the applied voltage of the cleaning roller 242.

Also as described above, the controller 8 calculates an after-transfer remaining toner quantity on a basis of a difference between a developing toner quantity predicted by using the prediction table 91 stored in the storage part 9 and an on-belt toner quantity. Using the prediction table 91 makes it possible to easily acquire a developing toner quantity fed from the developing part 23 to the photosensitive drum 21 for the formation of a toner image. That is, it becomes implementable to promptly execute the above-described calibration with a convenient configuration.

In addition, when the calibration for adjusting the applied voltage of the cleaning roller 242 is continuously executed, the applied voltage tends to increase gradually. That is, the applied voltage of the cleaning roller 242 approaches the maximum applicable voltage Vmax. Accordingly, when the difference between the adjusted applied voltage of the cleaning roller 242 and the maximum applicable voltage Vmax has come to a specified value or lower, the controller 8 gives a user information for prompting replacement of the cleaning roller 242 via the display part 2d.

According to this configuration, the user is enabled to prevent, in advance, occurrence of uncollected toner on the photosensitive drum 21. Therefore, occurrence of image defectives can be suppressed in the image forming apparatus 1, allowing the user to continuously obtain printed matters with high-quality image formation fulfilled.

In a case where the apparatus is so made up that the cleaning roller 242 is integrated with the drum cleaning part 24 or the image forming parts 20 so as to be individually unreplaceable, replacement of the drum cleaning part 24 or the image forming parts 20 may be urged on occasion of replacement of the cleaning roller 242.

Although an embodiment of this disclosure has been fully described hereinabove, yet the disclosure is not limited to the scope of this description and may be modified in various ways unless those modifications depart from the gist of the disclosure.

For instance, in the above embodiment, the image forming apparatus 1 is so configured as to include the intermediate transfer belt 31 to which toner images formed by the four image forming parts 20 are transferred in superimposition one after another. However, the apparatus is not limited to such ones. The present disclosure is also applicable to image forming apparatuses equipped with a conveyance belt that conveys a paper sheet to which toner images are transferred from the photosensitive drum, as an example.

Also in the above embodiment, the image forming apparatus 1 is described as a so-called tandem-type image forming apparatus for color printing. However, the image forming apparatus is not limited to such models. The image forming apparatus, as long as it includes an intermediate transfer belt, may be a color-printing image forming apparatus of any type other than the tandem type.

What is claimed is:

1. An image forming apparatus comprising:
an image carrier in which a photosensitive layer is formed on an outer circumferential surface of the image carrier;
a charging part for electrically charging the outer circumferential surface of the image carrier to a specified surface potential;
an exposure part for making the outer circumferential surface of the image carrier, which has been electrically charged by the charging part, exposed to light to form an electrostatic latent image with its charging level attenuated;
a developing part for feeding toner to the electrostatic latent image on the image carrier to form a toner image, and moreover collecting the toner remaining on the outer circumferential surface of the image carrier;
a belt placed so as to face the image carrier;
a transfer part for transferring the toner image, which has been formed on the outer circumferential surface of the image carrier, onto an outer circumferential surface of the belt;
a cleaning roller for removing and collecting deposits on the outer circumferential surface of the image carrier;
a voltage application part for controlling electrical energization for the charging part, the developing part, the transfer part, and the cleaning roller;
a concentration detection part for detecting a toner concentration of the toner image transferred onto the outer circumferential surface of the belt; and
a controller for controlling the image carrier, the charging part, the developing part, the transfer part, the cleaning roller, and the voltage application part, wherein
the controller:
makes a reference image, which is the toner image, formed on the outer circumferential surface of the image carrier and transferred onto the outer circumferential surface of the belt;
makes uncollected toner of the reference image, which is part of after-transfer remaining toner of the reference image that has missed being collected by the cleaning roller and the developing part and remains even after one-round rotation of the image carrier, transferred to the outer circumferential surface of the belt;
estimates an uncollected toner quantity on a basis of the toner concentration of the uncollected toner detected by the concentration detection part, and moreover measures a collectable toner quantity corresponding to an applied voltage of the cleaning roller on a basis of the uncollected toner quantity; and
adjusts the applied voltage of the cleaning roller so that the collectable toner quantity becomes equal to or larger than a maximum value of the after-transfer remaining toner quantity while the applied voltage of the cleaning roller becomes equal to or lower than a maximum applicable voltage.

2. The image forming apparatus according to claim 1, wherein
the controller varies the applied voltage of the cleaning roller in plural steps to measure the uncollected toner quantity corresponding to the after-transfer remaining toner quantity.

3. The image forming apparatus according to claim 1, further comprising
an informing part for informing about a status of the image forming apparatus, wherein
when a difference between the adjusted applied voltage of the cleaning roller and the maximum applicable voltage has become equal to or lower than a specified value, the controller issues information via the informing part to urge replacement of the cleaning roller.

4. The image forming apparatus according to claim 1, further comprising
a storage part in which stored is a prediction table for predicting a developing toner quantity fed from the developing part to the image carrier in process of forming the toner image on a basis of an on-belt toner quantity of the toner image transferred to the outer circumferential surface of the belt, wherein
the controller calculates the after-transfer remaining toner quantity on a basis of a difference between the developing toner quantity and the on-belt toner quantity.
